(19) United States
(12) Patent Application Publication
(10) Pub. No.: US 2025/0328496 A1
(43) Pub. Date: Oct. 23, 2025

(54) DYNAMIC DOCUMENT ANNOTATION SYSTEM

(71) Applicant: Citigroup Inc., New York, NY (US)

(72) Inventors: Minjeong Cho, London (GB); Jason Ryan Engelbrecht, London (GB); Ines Teixeira, London (GB); Alberto Cetoli, London (GB)

(21) Appl. No.: 18/642,744

(22) Filed: Apr. 22, 2024

(51) Int. Cl. G06F 16/16; G06F 16/14

(52) U.S. Cl. CPC G06F 16/164; G06F 16/144

(57) ABSTRACT

A query is generated using metadata of a document. A set of candidate locations in the document to be annotated is identified as corresponding to the metadata. A set of scores is generated for the set of candidate locations using a neural network, where the set of scores indicate whether individual candidate locations satisfy the query. Based on the set of scores, a candidate location is annotated to generate an annotated candidate location as corresponding to the metadata.

### BACKGROUND

Natural Language Processing and Large Language Models typically require training data for training neural networks to be labeled prior to training. In cases where metadata about original documents already exists, mapping the metadata to specific locations in the documents such that the documents and labels can be used as training data to train machine learning models is a manual process. However, the enormous amount of data needed to train neural networks makes manual labeling impractically time-consuming, costly, and prone to error.

### BRIEF DESCRIPTION OF THE DRAWINGS

Various techniques will be described with reference to the drawings, in which:

FIG. 1 illustrates an overview of an example annotation system, in accordance with an embodiment;

FIG. 2 illustrates an example of identifying a candidate location using string matching, in accordance with an embodiment;

FIG. 3 illustrates an example of linking metadata to an original document, in accordance with an embodiment;

FIG. 4 illustrates an example of identifying a candidate location using a knowledge base, in accordance with an embodiment;

FIG. 5 illustrates a flowchart of an algorithm to link metadata to documents, in accordance with an embodiment;

FIG. 6 illustrates a flowchart of an example of a machine learning model identifying candidate locations in a document, in accordance with an embodiment;

FIG. 7 illustrates an application programming interface that returns a candidate location, in accordance with an embodiment; and

FIG. 8 illustrates an example of a computing device that may be used in accordance with at least one embodiment/an environment in which various embodiments can be implemented.

### DETAILED DESCRIPTION

The present application describes systems and techniques to dynamically correlate metadata to a document, and generate training labels usable for training natural language processing (NLP) operations. In an embodiment, a query is generated using metadata of a document. In the embodiment, a set of candidate locations is identified in the document to be annotated as corresponding to the metadata. Further in the embodiment, a set of scores for the set of candidate locations is generated using a neural network, where the set of scores indicate whether the candidate locations satisfy the query. Then, in the embodiment, a candidate location is annotated as corresponding to the metadata based on the set of scores.

In at least one embodiment, a system generates candidate locations in a document as potentially corresponding to metadata associated with a document or a document bundle, and input text, near the set of candidate locations, and a query (e.g., natural language query) derived from metadata into a neural network (e.g., an encoder-based model) to obtain entailment scores that indicate how well text at the location satisfies the query. If an entailment score exceeds a value relative to a threshold, then the location of the corresponding candidate data items may be annotated as corresponding to the metadata.

In one example, a system performs dynamic annotation using an algorithm. where the algorithm may be agnostic as to the type of document that is input. In this manner, the system of the present disclosure may be used for various types of documents (e.g., contracts, textbooks, passports, driver's licenses, etc.). In at least one embodiment, a system generates the natural language queries from metadata of an original document. For example, if metadata was manually entered by a human, the system may change this metadata into a human understandable query. In at least one embodiment, the system transforms this manually recorded metadata into annotations for machine learning models. In at least one embodiment, the metadata includes portions of data near the candidate information. In at least one embodiment, the amount of the portions of data and distances of the portions from the candidate information may be configurable based on one or more parameters.

In an embodiment, the system identifies candidate answers (e.g., strings of characters potentially corresponding to locations in the original document) using string matching. In at least one embodiment, if a string metric (e.g., edit distance) of these candidate answers reaches a value relative to a threshold value (e.g., meet or exceed the threshold value) corresponding to a similarity between the metadata and characters within the document, then these candidate answers are selected as potential candidates for the document annotation (linking the metadata to the document). The system may then add relevant information from a knowledge base to reduce the risk of omitting metadata due to insufficient information in the document to map unknown terms to the metadata. The knowledge base may include terms that are relevant to the metadata, as the terms may be alternate names for a person (e.g., “Michael,” “Mike,” “Ike,” etc.), places (e.g., “New York,” “NY,” “N.Y.,” etc.), or things (e.g., “contract,” “agreement,” “record,” “obligation,” etc.) that are the subjects of the metadata to be linked to the original document. For example, in at least one embodiment, a knowledge base includes synonyms, acronyms, and names that result from a combination of two things. In at least one embodiment, the knowledge base may include various date and time formats. By using the information found in the knowledge base to perform additional queries, the system reduces the chances of overlooking matches to terms that are synonyms of key terms, acronyms of key terms, or new names of combined entities.

In various embodiments, a “match” does not necessarily require equality. For example, two values may match if they are equivalent but not necessarily equal. As another example, two values may match if they correspond to a common object (e.g., value) or are in some predetermined way complementary and/or they satisfy one or more matching criteria. Generally, any way of determining whether there is a match may be used.

The system may then select a final answer from the candidate answers using an entailment score that indicates a likelihood that the candidate answers can be inferred from the metadata that is in the form of the query. For example, if a candidate answer entails (logically follows) the natural language query (as indicated by the entailment score being a value relative to a threshold value, such as exceeding the threshold value) that was generated by transforming the metadata of the document, then the candidate answer may be considered for the final answer. Conversely, if the candidate answer cannot be inferred from the metadata, for example, the candidate answer contradicts to the query or is inconclusive, then the candidate answer may not be considered for the final answer. The location of the candidate answer with the highest score may be “highlighted,” annotated, or otherwise indicated in the document (such as, drawing a bounding box around the candidate answer that matches the metadata), and text of the query and the entailment score. The document annotation data that correlates the metadata to corresponding portions of the original document may be used to generate training labels for natural language processing models.

Techniques described and suggested in the present disclosure improve the field of computing, especially the field of natural language processing and large language models, by enabling labels to be dynamically correlated to portions of the original document without human supervision. Additionally, techniques described and suggested in the present disclosure improve the efficiency and functioning of computing systems by allowing computing systems to dynamically annotate specific locations in documents that correspond to the metadata. Moreover, techniques described and suggested in the present disclosure are necessarily rooted in computer technology in order to overcome problems specifically arising with training neural networks, by eliminating the need to manually label training data. In this manner, the techniques of the present disclosure is more efficient and less error-prone than manual labeling.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Any system or apparatus feature as described herein may also be provided as a method feature, and vice versa. System and/or apparatus aspects described functionally (including means plus function features) may be expressed alternatively in terms of their corresponding structure, such as a suitably programmed processor and associated memory. It should also be appreciated that particular combinations of the various features described and defined in any aspects of the present disclosure can be implemented and/or supplied and/or used independently.

The present disclosure also provides computer programs and computer program products comprising software code adapted, when executed on a data processing apparatus, to perform any of the methods and/or for embodying any of the apparatus and system features described herein, including any or all of the component steps of any method. The present disclosure also provides a computer or computing system (including networked or distributed systems) having an operating system which supports a computer program for carrying out any of the methods described herein and/or for embodying any of the apparatus or system features described herein. The present disclosure also provides a computer readable media having stored thereon any one or more of the computer programs aforesaid. The present disclosure also provides a signal carrying any one or more of the computer programs aforesaid. The present disclosure extends to methods and/or apparatus and/or systems as herein described with reference to the accompanying drawings. To further describe the present technology, examples are now provided with reference to the figures.

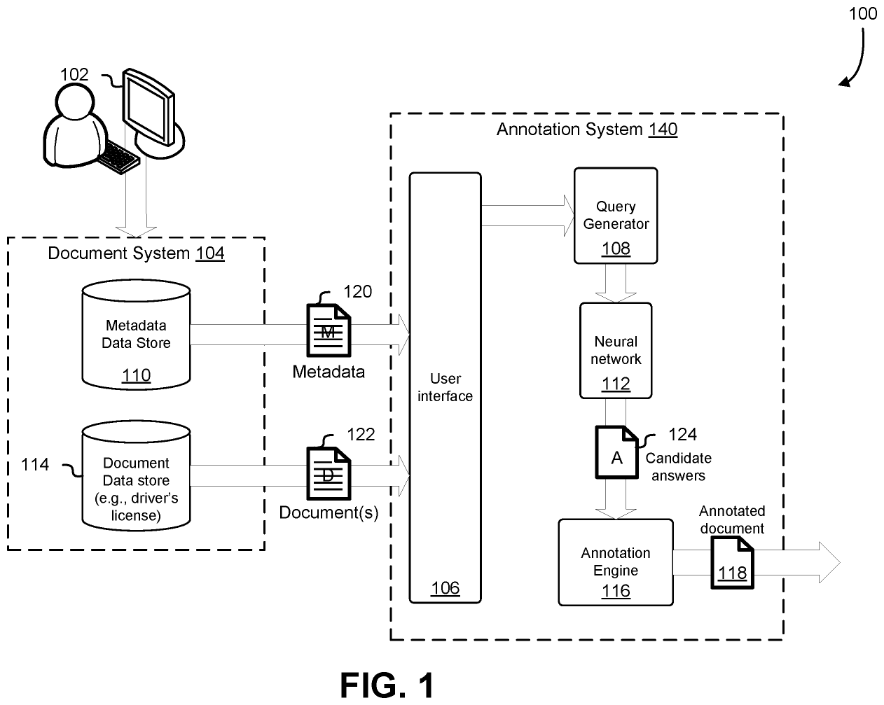

FIG. 1 illustrates an aspect of an environment 100 for a dynamic annotation system 140 in which an embodiment may be practiced. In some embodiments, users of this environment 100 include but are not limited to client users of the dynamic annotation system 140. In at least one embodiment, as illustrated in FIG. 1, the environment 100 includes an annotation system 140 as described herein, that receives, at a user interface 106, a request from a user 102 via a client device, which causes a query generator 108 to obtain from a document system 104 metadata, such as metadata 120, and a corresponding document, such as document 122, from a metadata database, such as metadata data store 110, and a document data store, such as document data store 114, respectively.

In at least one embodiment, the document system 104 may be a client device (e.g., laptop, mobile phone, desktop computer, etc.) or may be a server or distributed systems. In some embodiments, the document system 104 is external to the annotation system 140. In other embodiments, the document system 104 may be a part of the annotation system 140. In at least one embodiment, the document system 104 includes the metadata data store 110 and the document data store 114.

The query generator 108 generates the query, which the query generator 108 provides to a neural network 112, which outputs a set of candidate answers 124, also known as candidate locations, to an annotation engine 116. The annotation engine 116 selects the candidate from the candidate answers 124 and generates an annotated document, such as an annotated document 118.

In at least one embodiment, one or more processors of the annotation system 140, such as annotation system 140, generate a set of candidate answers 124, also known as candidate locations, in the document 122, as potentially corresponding to metadata 120 of the document 122, and input a plurality of text, near the set of candidate locations, and a query derived from the metadata 120 into a neural network (e.g., an encoder-based model) to obtain a set of entailment scores that indicate how well text at the location satisfies the query. In at least one embodiment, if an entailment score exceeds a value relative to (e.g., meets or exceeds) a threshold, then the location of the corresponding candidate data items may be annotated to create an annotated document, such as annotated document 118, as corresponding to the metadata 120. In at least one embodiment, the neural network 112 can be a large language model, for example, an encoder-based model. In at least one embodiment, the neural network 112 can be a large language model, for example, which includes, but is not limited to, Bidirectional Encoder Representations from Transformer (BERT), ChatGPT, GPT-4, and LLaMA 2.

In at least one embodiment, the user 102 may be one or more of individuals, computing systems, applications, services, resources, or other entities using a dynamic annotation system 140. For example, the user 102 may be an individual performing normal job responsibilities and/or a person who assumes the role of domain expert. A domain expert may be any individual with extensive experience and knowledge or skills in a specific area. In at least one embodiment, the user 102. The user 102 may have a distinct identifier (e.g., username, personal identification number (PIN), email address, etc.) associated with an account with a computing resource service provider associated with the dynamic annotation system 140 and may present, or otherwise prove, the possession of security credentials, such as by inputting a password, access key, and/or digital signature, to gain access to computing resources of the account. In some embodiments, possession of the security credentials may be proven using multifactor authentication. The user 102 may be a customer of the computing resource service provider. In at least one embodiment, the user 102 accesses the dynamic annotation system 140 using a client device or the document system 104 via the user interface 106.

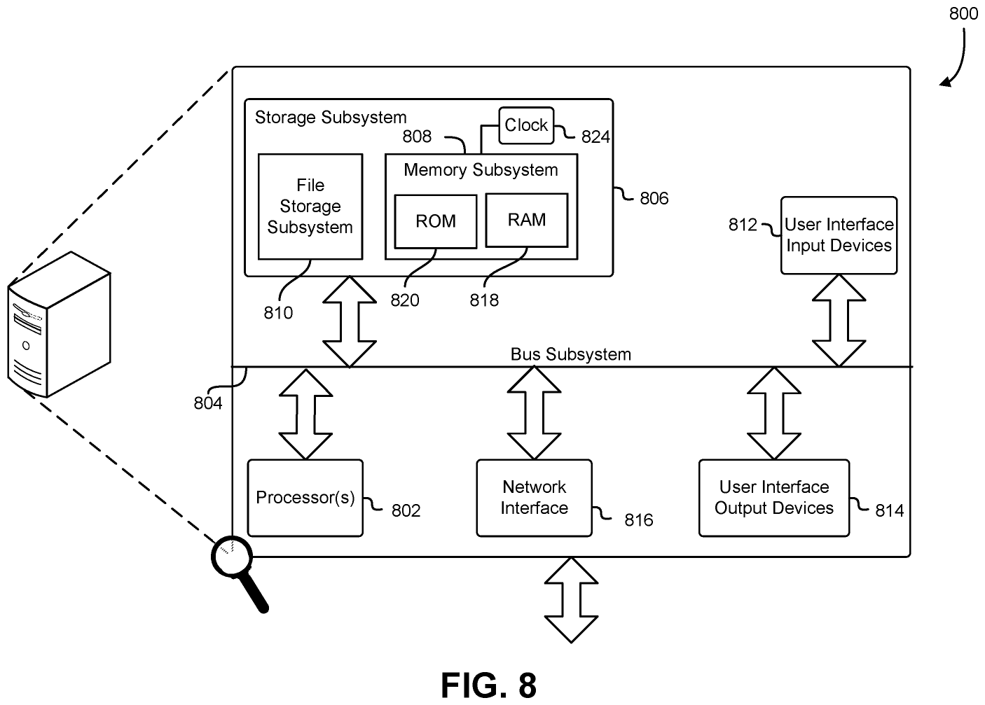

In at least one embodiment, the client device may include any appropriate device operable to send and/or receive requests, messages, or information over a network and convey information back to the user 102 of the client device. Examples of such client devices include personal computers, cellular or other mobile phones, handheld messaging devices, laptop computers, tablet computers, set-top boxes, personal data assistants, embedded computer systems, electronic book readers, and the like, such as the computing device 800 of FIG. 8. In at least one embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In at least one embodiment, communication over the network is enabled by wired and/or wireless connections and combinations thereof. In an embodiment, the network includes the Internet and/or other publicly addressable communications networks, as the system includes a web server for receiving requests and serving content in response thereto, although for other networks an alternative device serving a similar purpose could be used as would be apparent to one of ordinary skill in the art.

In at least one embodiment, the user interface 106 may be computer hardware or software designed to communicate information between hardware devices, between software programs, between devices and programs, or between a device and a user. In some embodiments the user interface 106 is a graphical user interface (GUI). In some embodiments, the user interface 106 is an API.

In at least one embodiment, the query generator 108 may be a computing system, software, software program, hardware device, module, or component capable of generating a natural language query by at least transforming manually recorded metadata of a corresponding document. In at least one embodiment, the query generator 108 may cause metadata to be ingested in the form of a natural language query that may include portions of data near the metadata title. For example, if the metadata 120 is:
<Surname>Smith</Surname>

The query generator 108 may generate a query such as:

“The document says that the Surname is Smith within the Driver's License.”

In at least one embodiment, the system receives metadata and a corresponding original document. In at least one embodiment, the query generator 108 generates a natural language query, a SQL query, or any other form of query that consists only of normal terms in the user's language, without any special syntax or format, by transforming metadata that corresponds to an original document. The query generator 108 obtains the corresponding document 122 from a document data store 114 and provides the natural language query and the corresponding document 122, as an input, to the neural network 112. In response, and the neural network 112 outputs a set of candidate answers 124. In at least one embodiment, an answer to the natural language query may be used to identify candidate answers in the document that correspond to the metadata. For example, the neural network 112, in response to the query “The document says that the Surname is Smith within the Driver's License,” may return an image file with a bounding box around “Smith,” an answer score, and bounding box coordinates.

In at least one embodiment, the metadata data store 110 and the document data store 114 may be a data store. In various embodiments, a data store is a repository for data objects, such as database records, flat files, or other data objects. Examples of data stores include file systems, relational databases, non-relational databases, object-oriented databases, comma-delimited files, and other files. In some embodiments, the data store is a distributed data store. The storage system included in storage subsystem 806 in FIG. 8 is an example of a data store. In at least one embodiment, a data store may include one or more data tables, databases, data documents, dynamic data storage schemes and/or other data storage mechanisms. The data store may comprise media for storing data relating to a particular aspect of the present disclosure. In an embodiment, the data stores illustrated in the environment 100 include mechanisms for storing data and user information, such as customers, which are used to serve content for the operations of the dynamic annotation system 140. The data store may also include a mechanism for storing log data, which may be used to provide various reports and/or error logs related to operations of the annotation system 140.

In at least one embodiment, the neural network 112 may be a machine learning model. In at least one embodiment, the machine learning model comprises software or data used to implement any of a variety of machine learning and artificial intelligence techniques. In at least one embodiment, the machine learning model comprises data that includes, but is not limited to, weights, biases, parameters, network definitions, and graph definitions. In at least one embodiment, a technique implemented by a machine learning model includes one or more of neural networks, linear regressions, decision trees, random forests, genetic algorithms, dimension reduction algorithms, supervised learning, unsupervised learning, and reinforcement learning.

In at least one embodiment the neural network 112 is a machine learning model that performs machine learning or inference tasks to identify candidate answers or candidate locations in an original document from the documents data store 114 that corresponds to metadata of the original document. In at least one embodiment, the machine learning or inference tasks may be initiated via an application programming interface (API). In at least one embodiment, the API is invoked by or on behalf of a client device to a system, such as annotation system in the environment 100 depicted in FIG. 1, which provides hosted machine learning capabilities.

In at least one embodiment, the annotation engine 116 is hardware or software comprising a system, service, application, or method that enables annotation of document, images, or other forms of digital media. In at least one embodiment, the annotation engine 116 may receive the output of the neural network 112. The output may comprise candidate answers corresponding to the metadata 120 in the original document 122. In at least one embodiment, if the outputs of the neural network indicate a match to the natural language query answer that (e.g., a score reaching a value meeting or exceeding a threshold value), then the annotation engine 116 may generate an annotated document 118, or annotation file. In at least one embodiment, this annotated document 118 may be in form or a JavaScript Object Notation (JSON) file that includes document name, page number, entity type (e.g., Surname, Date of Birth, or Place of Birth), answer score, and answer bounding box coordinates.

In at least one embodiment, the metadata 120 is data about the document (e.g., data that provides information about the document) which is maintained in the metadata data store 110 so that the metadata 120 is located, processed, and provided (or a streaming data object is initiated) for use in processing the query. For example, the metadata may include, for example, but is not limited, to entity types, entity values, and other characteristics of the recorded documents.

In at least one embodiment, the document 122 may be maintained in document data store 114 and located, processed, and provided for use in processing by the dynamic annotation system, as input, to the neural network 112. For example, documents may include, but is not limited to, a document bundles, driver's license, or passport. In at least one embodiment, each page of a document, such as document 122, may be independently processed and annotated separately from other pages. In at least one embodiment, each document, such as document 122, may be processed as a whole with all pages included.

In at least one embodiment, the set of candidate answers 124 may include text in the document 122 identified by the neural network 112 to have an overlap (e.g., quantifying how dissimilar two strings are to one another) with the metadata that reaches a value relative to a threshold value. In at least one embodiment, the candidate answers 124 have a value relative to the minimum number of operations required to transform the text of document 122 to the metadata (as the natural language query). In at least one embodiment, the candidate answers 124 may include scores derived from other edit distance or string metrics that allow different sets of sting operations.

In at least one embodiment, parts, methods and/or systems described in connection with FIG. 1 are as further illustrated non-exclusively in any of FIGS. 1-8.

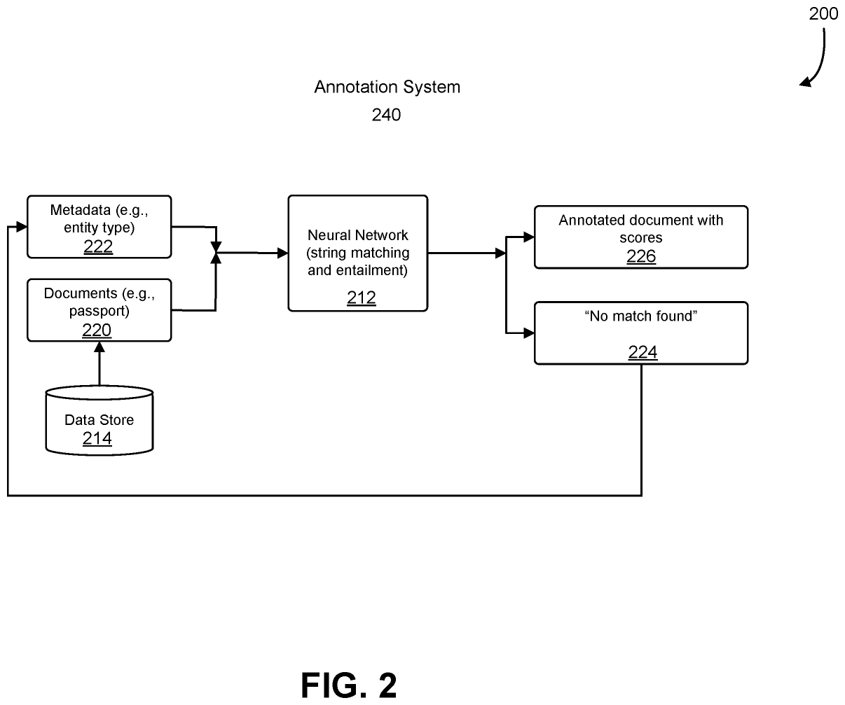

FIG. 2 illustrates an example 200 of identifying a candidate location using string matching, in accordance with an embodiment. In at least one embodiment, as illustrated in FIG. 2, an annotation system 240 as described herein, includes various components that include a neural network 212, data store 214, documents 220 and metadata 222 that may be provided as input to the neural network 212, “no match found” block 224, and an annotated document with scores 226 that are the output of the neural network 212. In at least one embodiment, the annotation system 240 is similar to the annotation system 140 in FIG. 1. In at least one embodiment, the neural network 212 is similar to the neural network 112 in FIG. 1. In at least one embodiment, the data store 214 is similar to the document data store 114 in FIG. 1.

In at least one embodiment, the annotation system 240 may receive obtain the metadata 222 from a metadata data store, such as, the metadata data store 110 in FIG. 1. In at least one embodiment, a user, such as, the user 102 in FIG. 1 inputs a document including images such as document 220 and metadata 222 to the annotation system 240. In at least one embodiment, one or more processors of the dynamic annotation system 140 perform instructions to annotate documents that are stored in the document data store 114 system using metadata that has been recorded. In at least one embodiment, the user 102 may enter the query, an specify the entity type and a candidate answer. For example, the query may be “The document says that the Surname is Smith within the Driver's License,” the entity type may be “Surname,” and the answer may include the corresponding surname in the driver's license, which in this case is “Smith.” In at least one embodiment, the entity type is a string or value indicating the type of data being searched for, in at least one embodiment, the uploaded documents and the uploaded metadata can be input to the neural network 212.

In at least one embodiment, the neural network 212 may receive input that includes a document (e.g., document bundles, passport, driver's license, etc.) and a corresponding metadata pair (to the document). In at least one embodiment, if match is found between the metadata (in the form of a query) and the candidate location in the document, the neural network 212 outputs an image file, such as, annotation document with scores 226. In at least one embodiment, if no match is found between the metadata (in the form of a query) and the candidate location in the document, the neural network 212 may output a message to a user interface, such as user interface 106, that “No match is found. Try again with different documents and/or metadata.”

In at least one embodiment, if the output of the neural network 212 is “no match”, the annotation system 240 may cause a process to perform sentence embedding. In at least one embodiment, sentence embedding may include a merge or cluster of contiguous bounding boxes (using paragraph indices). In at least one embodiment, if the output of the neural network 212 is “no match”, the annotation system 240 may cause a process to perform a summarization process (e.g., a generative model). In at least one embodiment, a summarization process may include creating a dataset of text in the document for a supervised learning model. In at least one embodiment, this summarization process may include, as input, a document 220 and metadata 222 and, as output, a relevant part in the document. In at least one embodiment, this dataset for supervising learning model can be used to train generative models. In at least one embodiment, this summarization process may be an algorithm that includes a generative model and an entailment model.

In at least one embodiment, the neural network 212 may be similar to neural network 112 in FIG. 1. In at least one embodiment, the neural network 212 is a deep neural network, such as the neural network 212. In at least one embodiment, a deep neural network is a neural network with two or more layers. In at least one embodiment, this large language model comprises a transformer model. In at least one embodiment, the neural network 212 is a large language model that is configured to perform natural language processing. In at least one embodiment, this large language model is configured to process one or more sequences of data, such as, a natural language query generated by transforming metadata, such as metadata 222. In at least one embodiment, large language model is configured to process text. In at least one embodiment, weights and biases of a large language model are configured to process text. In at least one embodiment, this large language model is configured to determine patterns in data to perform one or more natural language processing tasks.

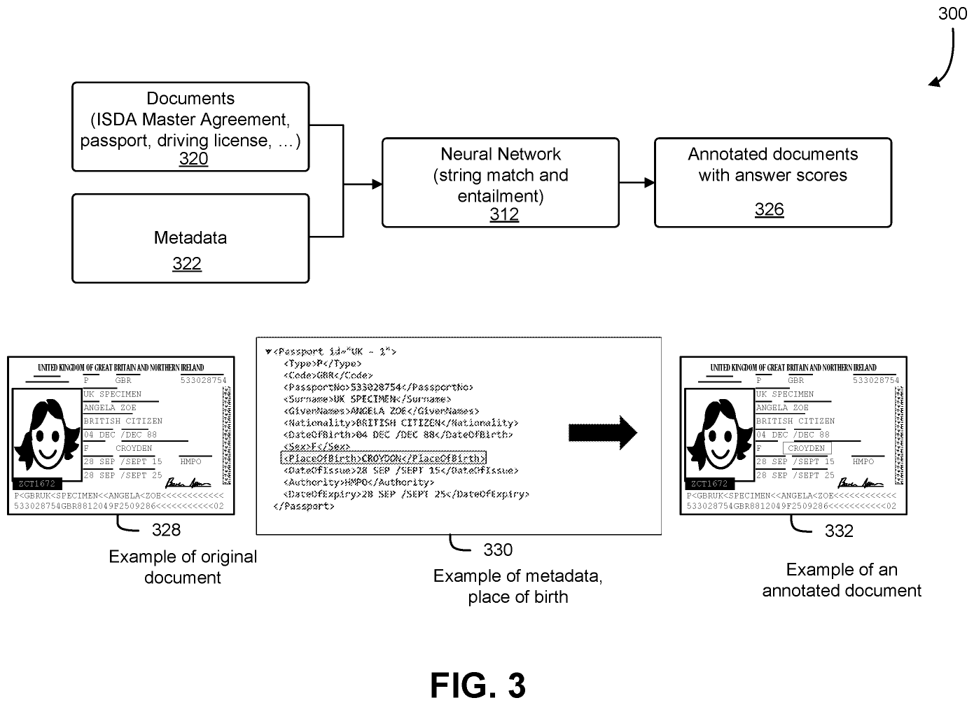

In at least one embodiment, a natural language processing task comprises text generation, such as an annotated document, such as annotated document 118 in FIG. 1, annotated document with answer scores 226 and 326 in FIG. 2 and FIG. 3, respectively. In at least one embodiment, a natural language processing task comprises question answering, such as annotated document with scores 226 that includes the query, entailment score, and a bounding box around the candidate answer. In at least one embodiment, this natural language processing task comprises question answering, such as “no match found” 224, as an output of the neural network 212 indicating that a candidate string of document 220 does not satisfy or exceed a string metric threshold value. In at least one embodiment, performing a natural language processing task results in output data.

In at least one embodiment, the neural network 212 may perform AI-assisted annotation to aid in generating annotations corresponding to documents, such as those from documents data store 114, to be used as ground truth data for a machine learning model. In at least one embodiment, AI-assisted annotation may include one or more machine learning models (e.g., convolutional neural networks (CNNs)) that may be trained to generate annotations corresponding to certain types of metadata identified and correlated to original documents (e.g., from certain devices) and/or certain types of anomalies in data. In at least one embodiment, AI-assisted annotations may then be used directly, or may be adjusted or fine-tuned using an annotation engine tool, such as annotation engine 116 in FIG. 1 (e.g., by a data analyst, etc.), to generate ground truth data. In at least one embodiment, in some examples, labeled data, such as annotated document 118 in FIG. 1 may be used as ground truth data for training a machine learning model. In at least one embodiment, AI-assisted annotations, labeled data, or a combination thereof may be used as ground truth data for training a machine learning model. In at least one embodiment, a trained machine learning model may be referred to as output model, and may be used by the dynamic annotation system 140 in environment 100 of FIG. 1, as described herein.

In at least one embodiment, parts, methods and/or systems described in connection with FIG. 2 are as further illustrated non-exclusively in any of FIGS. 1-8.

FIG. 3 illustrates an example of linking metadata to an original document, in accordance with an embodiment. As illustrated in FIG. 3, the example 300 includes one or more documents 320 (such as an original document 328) and metadata 322 (such as metadata place of birth 330) corresponding to the documents 320 being provided to a neural network 312, with the resulting end-product being one or more annotated documents with answer scores 326 (such as an annotated document 332).

In at least one embodiment, the neural network 312 is similar to the neural network 112 in FIG. 1 and neural network 212 in FIG. 2. In at least one embodiment, document 220 is similar to documents 220 in FIG. 2, metadata 322 is similar to metadata 222 in FIG. 2, and annotated documents with answer scores 326 is similar to annotated documents with scores 226 in FIG. 2.

In at least one embodiment, one or more processors of a dynamic annotation system, such as, annotation system 140 in FIG. 1 may cause instructions to be performed that dynamically correlate metadata 322 to original documents 320 using the neural network 312, and generate annotated documents 326 to be used as training labels for natural language processing tasks, as described herein.

In at least one embodiment, a processor of annotation system 140 performs instructions that may be an algorithm that links metadata 322 to an original document of documents 320. In at least one embodiment, the annotation system 140 may receive a document, such as, the original document 328 and metadata, such as, metadata place of birth 330. In at least one embodiment, the processor of the annotation system 140 performs instructions that transform a specific field of metadata, such as, metadata place of birth 330 into a natural language query. For example, an annotation system may transform metadata:

$$〈 PlaceOfBirth 〉 CROYDON 〈 / PlaceOfBirth 〉$$

To a natural language query:
“The document says that the PlaceOfBirth is CROYDON within the Passport.

In at least one embodiment, the processor of annotation system 140 performs instructions to identify candidate answers in a document, such as, original document 328, using string matching. If an overlap (e.g., difference between two sequence of characters), between the metadata and the part of the document, exceeds a value relative to a threshold value, then the candidate answer may be added to a candidate answer list.

In at least one embodiment, the processor of the annotation system 140 may perform instructions that add relevant information into a knowledge base. For example, the knowledge base may include synonyms, acronyms, and names of things that result from a combination of at least two things.

In at least one embodiment, the processor of the annotation system 140 uses the neural network 312, to select a final candidate answer, from a set candidate scores, with the highest entailment score. In at least one embodiment, the entailment score may be generated using a premise that may include portions of text around the candidate answer and a hypothesis that may include a natural language query.

In at least one embodiment, the processor of the annotation system 140 performs instructions that cause the neural network 312 to output the annotated document (with scores) 326. In at least one embodiment, the annotated document 326 may include the query, entailment score, and bounding box coordinates. For example, annotated document 332 includes a bounding box that surrounds the text at the location in the document corresponding to the metadata, which, in this case, is “CROYDON.”

In at least one embodiment, parts, methods and/or systems described in connection with FIG. 3 are as further illustrated non-exclusively in any of FIGS. 1-8.

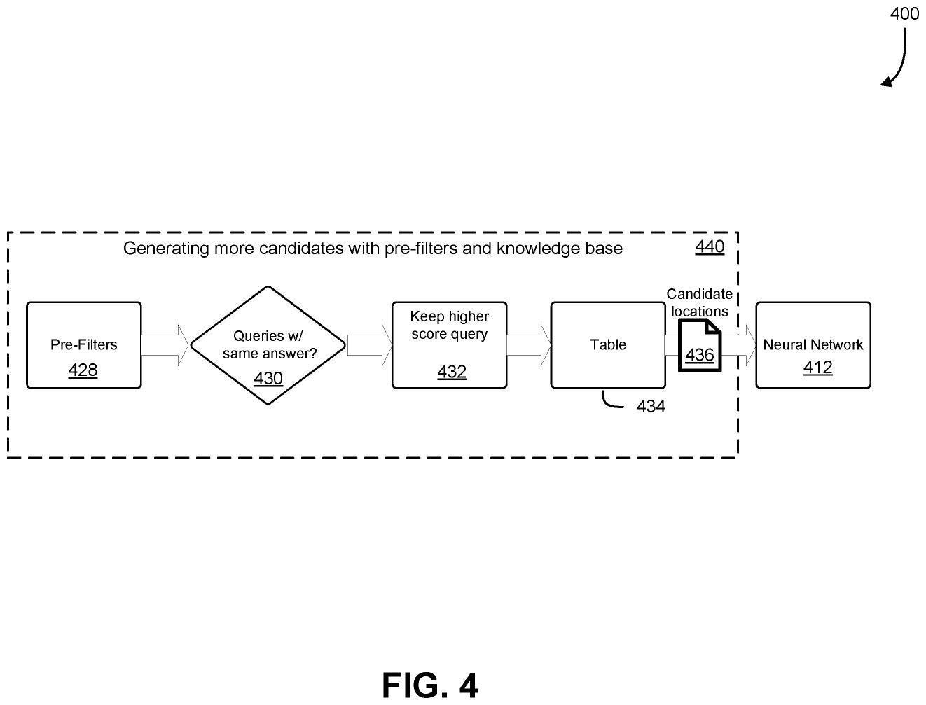

FIG. 4 illustrates an example of identifying a candidate location using a knowledge base, in accordance with an embodiment. As illustrated in FIG. 4, the example 400 is of a process of generating more candidates with pre-filters and knowledge base 440, which includes a neural network 412 that receives candidate locations 436. These candidate locations 436 result from applying pre-filters 428 to queries, asking if different queries have the same bounding box (same answer) at decision block 430, and if different queries have the same answer, deciding to keep only the one with the higher candidate score query 432, and maintain a table 434 that includes a knowledge base.

In at least one embodiment, the neural network 412 is similar to neural network 112 in FIG. 1, neural network 212 in FIG. 2, and neural network 312 in FIG. 3. In at least one embodiment, a processor of annotation system, such as, annotation system 140 in FIG. 1 and annotation system 240 in FIG. 2 may perform instructions to generate candidate answers using pre-filters and a knowledge base 440. In at least one embodiment, a processor of annotation system, such as, annotation system 140 may perform instructions to use pre-filters 428 in queries, such as natural language queries, using specified metadata items. In at least one embodiment, pre-filters 428 may include quantitative items and other items specified by users and/or customers of annotation system 140.

In at least one embodiment, if different queries have the same bounding box 430 (i.e., same answer), a processor of the annotation system 140 performs instructions to keep only one query with the higher candidate answer score 432. For example, different metadata items can occupy the same bounding box if the metadata items share some of the same character strings. In at least one embodiment, if different queries have the same bounding box 430 (i.e., same answer), an annotation system 140 may receive a list of metadata items from a user, such as, user 102 in FIG. 1 via a user interface, such as, user interface 106 in FIG. 1 to parse, when generating queries to link the metadata to an original document, such as, documents 220 in FIG. 2 and documents 320 in FIG. 3.

In at least one embodiment, a processor of the annotation system 140 performs instructions to obtain candidate answers in bounding boxes that would, otherwise, have been missed due to insufficient information relating to some terms in the document. For example, an annotation system may not detect potential candidate answers due to insufficient information that would, otherwise, map these potential candidate answers to metadata of an original document. In at least one embodiment, a processor of the annotation system 140 may use metadata associated with pre-filters 428 to add relevant information to a knowledge base. In at least one embodiment, a knowledge base may include a table of synonyms, acronyms, and names that result from a combination of two things 434. In at least one embodiment, the knowledge base may include various date and time formats.

In at least one embodiment, the processor of the annotation system 140 may perform instructions to generate a table for synonyms, acronyms, abbreviations, names of combined things 434 to replace relevant parts of the text in an original document. In at least one embodiment, this table 434 may be used to generate additional candidate answers or candidate locations 436 in a document. In at least one embodiment, the processor of the annotation system 140 may perform instructions to link metadata to an original document by generating candidate answers to a natural language query (derived from metadata of the original document), using a neural network 412.

In at least one embodiment, parts, methods and/or systems described in connection with FIG. 4 are as further illustrated non-exclusively in any of FIGS. 1-8.

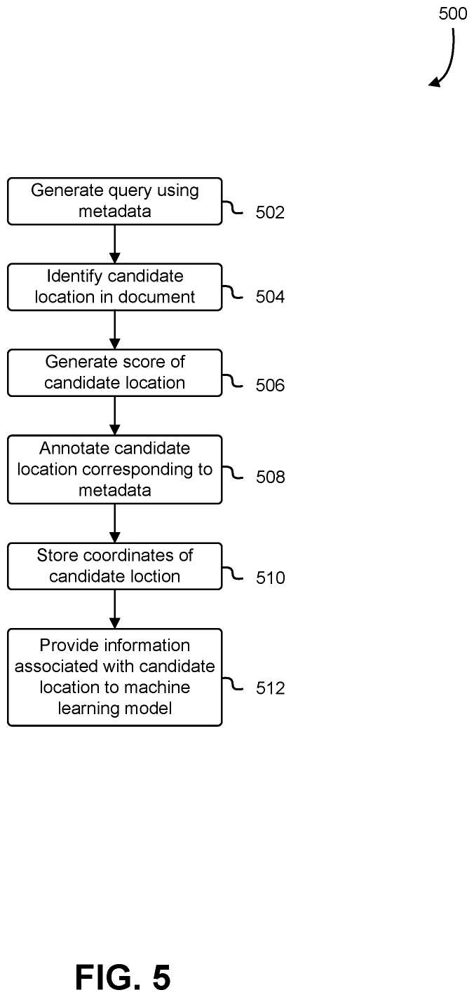

FIG. 5 is a flowchart illustrating an example of a process 500 of an algorithm that links metadata to documents, in accordance with various embodiments. Some or all of the process 500 (or any other processes described, or variations and/or combinations of those processes) may be performed by one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 500 may be performed by any suitable system, such as the computing device 800 of FIG. 8. The process 500 includes a series of operations wherein a request is received by the system performing process 500 to annotate documents corresponding to metadata associated with the documents, using metadata that was previously recorded to create document annotations as input for machine learning extractions. In at least one embodiment, the system dynamically annotates documents using recorded metadata.

In at least one embodiment, in 502, one or more processors of an annotation system, or otherwise known as a computing system or system, generates a query using metadata. In at least one embodiment, this system transforms metadata associated with an original document into natural language queries (NLQ). In at least one embodiment, a query, also known as an NLQ, allows a human to ask questions related to data within an analytics platform, using everyday language as the human would to another human, to obtain information for machine learning extraction. For example, metadata associated with an original document, in this case a driver's license, such as, <Surname>Smith</Surname>, may be transformed into a query that asks: The document says that the Surname is SMITH within the Driver's License. In at least one embodiment, the metadata was created manually.

In at least one embodiment, in 504, one or more processors of a system identifies a candidate location, or otherwise known as candidate answer, which matches the metadata in locations in the documents. In at least one embodiment, this system may identify candidate answers using string matching. For example, if an overlap between the metadata and the part or location of the document is a value that satisfies a relative threshold value, the location may be added as a candidate answer. In at least one embodiment, an overlap between the metadata and the location may be computed using a string metric (e.g., Levenshtein distance) that measures the difference between two words (e.g., sequence or string of characters). For example, the overlap between the metadata and the document is a measure of how similar the two strings are. A value of the overlap may be generated by measuring the minimum number of character edits required to change one string of characters into the other string of characters.

In embodiments, if the overlap between the metadata and the candidate string at a location of the document indicates a score or scores at a value that is below a relative threshold, then a candidate answer generator process running on a client device may cause the client device to not use the candidate string as a candidate answer, and instead analyze different candidate locations and/or different documents and metadata. Conversely, if the candidate string indicates, such as by, a score or scores at a value relative to a threshold (e.g., at the threshold, above the threshold, etc.), that the candidate string is likely to be correct, and the candidate answer generator process running on the client device may cause the client device to add the candidate string to a set of candidate answers.

In at least one embodiment, in 506, the system generates a set of candidate scores for the set of candidate locations, the set of candidate scores indicating whether the candidate locations satisfy a query (e.g., a natural language query). In at least one embodiment, the system selects the final answer using an entailment score that includes using a premise and a hypothesis. In at least one embodiment, the premise may be portions of text around the candidate answer. In at least one embodiment, the hypothesis may be metadata that has been transformed into a query, such as, a natural language query. In at least one embodiment, the system may perform a natural language inference (NLI) to determine whether the hypothesis is true, and if the hypothesis is true a candidate string is labelled as entailment. In at least one embodiment, if the NLI indicates that the hypothesis is false, then the candidate string it labelled as a contradiction or neutral. For example, if a premise was a football game with multiple people playing and the hypothesis was some people are playing a game, then the system performing a NLI may label the hypothesis an entailment, because it is logical to infer that people are playing a game from the premise. Conversely if the premise and hypothesis do not logically flow then the hypothesis may be labelled a contradiction. For example, it would be illogical to infer that people are sleeping form the premise of a football game with multiple people playing. Lastly, if the hypothesis is undetermined given the premise it would be labelled as neutral.

In at least one embodiment, a premise is portions of text around a candidate answer and the hypothesis is the natural language query which has been translated from metadata of an original document, such as document 220 in FIG. 2. For example, the hypothesis may be “The document says that the Surname is SMITH within the Driver's License” and the premise will be a plurality of text around the candidate answer. If the premise and hypothesis are matching with each other, then the score of the candidate answer will be a high score. In at least one embodiment, the system selects the highest score of a set of scores as the final answer using the entailment score.

In at least one embodiment, in 508, the system may annotate a candidate location as corresponding to the metadata by using the set of scores. In at least one embodiment, if candidate answer has value that exceeds a relative threshold value, then an annotation file is created.

In at least one embodiment, the system may store information of the annotated document (e.g., coordinates of the location) 510. In at least one embodiment, the annotation file may comprise a JSON file that includes a document name, page number, entity name, answer score, answer; and bounding box coordinates. In at least one embodiment, in 512, the system provides information of the annotated document to a neural network, by generating training labels for natural language processing (NLP) tasks. In at least one embodiment, the labels may be used for training a neural network (e.g., large language models). In at least one embodiment, the processor of the annotation system 140 causes a neural network to modify new metadata obtained by the annotation system 140 subsequent to the annotation system 140 generating the annotated document, such as, annotated document 118 in FIG. 1, annotated document 226 in FIG. 2, and annotated document 326 in FIG. 3.

In at least one embodiment, an exemplary process 500 includes a processor using one or more circuits of an annotation system to dynamically correlate metadata and original documents and/or otherwise perform operations described herein. In at least one embodiment, parts, methods and/or systems described in connection with FIG. 5 are as further illustrated non-exclusively in any FIG. 1-8.

Note that one or more of the operations performed in 502-12 may be performed in various orders and combinations, including in parallel.

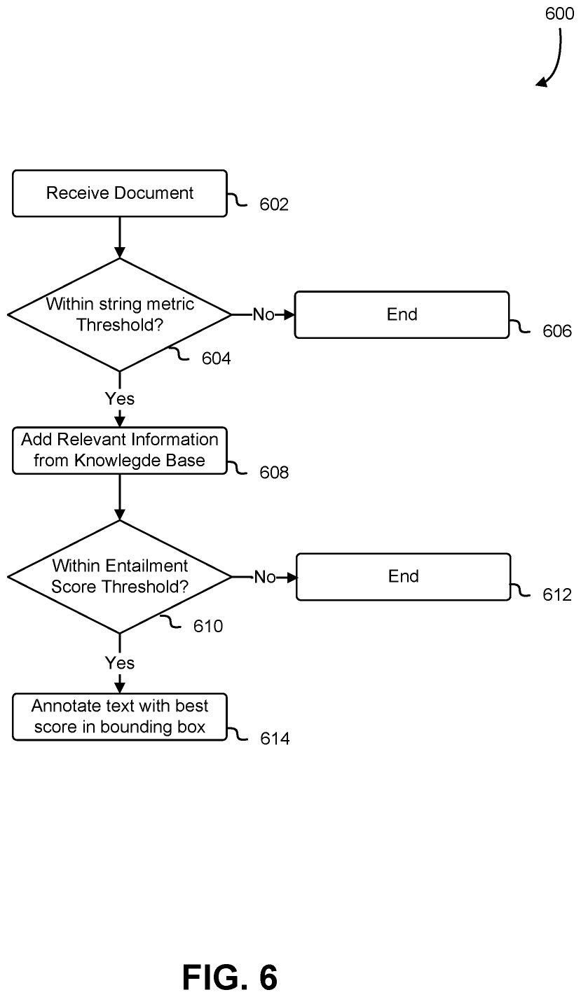

FIG. 6 is a flowchart illustrating an example of a process 600 for an algorithm to correlate or link metadata to documents, in accordance with various embodiments. Some or all of the process 600 (or any other processes described, or variations and/or combinations of those processes) may be performed by computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 800 of FIG. 8. The process 600 includes a series of operations wherein a document is received by the system performing process 600 to annotate text associated with a candidate location with the highest score in a bounding box. In at least one embodiment, the system dynamically annotates documents using recorded metadata.

In at least one embodiment, in 602, one or more processors of an annotation system, or otherwise known as a computing system or system, receives a document.

In at least one embodiment, in 604, if the overlap between the metadata and the document or document bundle is within or exceeds a string metric threshold value, then the one or more processors of the system performing the process 600 may proceed to 608, whereupon, the one or more processors of the system causes a process to record add relevant information from a knowledge base, otherwise the system performing process 600 may proceed to 606, whereupon the system may do nothing or perform the process 600 with different document(s) and/or metadata. In at least one embodiment, the overlap between the a string of characters representing the metadata and a string of characters representing the document may be a measure of how similar the two strings are to each other.

In at least one embodiment, in 608, the system performing the process 600 may proceed to 610, whereupon, if the candidate answers have a value that satisfies a relative entailment score threshold, then the one or more processors of the system performing the process 600 may proceed to 614, whereupon the one or more processors of the system causes a process to annotate text of the location in the document corresponding to the metadata with the highest score in a bounding box.

Otherwise, if a value of a candidate answer does not satisfy (e.g., is below a threshold value) a relative entailment score threshold, then the system performing the process 600 may proceed to 612, whereupon the system may do nothing or perform the process 600 with different document(s) and/or metadata. In at least one embodiment, parts, methods and/or systems described in connection with FIG. 6 are as further illustrated non-exclusively in any of FIGS. 1-8.

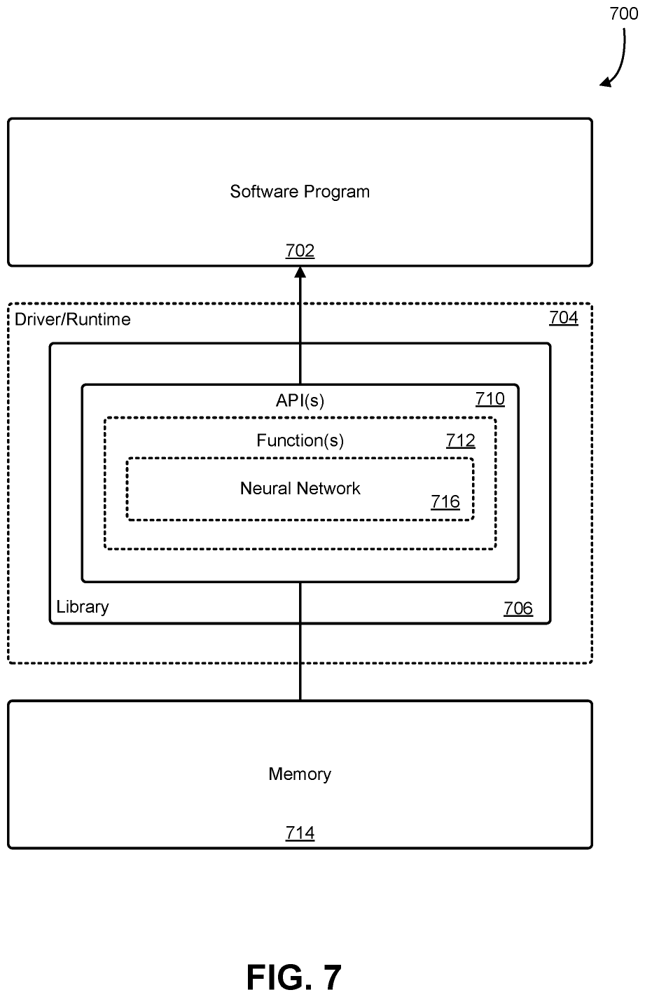

FIG. 7 is a block diagram illustrating driver and/or runtime software comprising one or more libraries to provide one or more application programming interfaces (APIs), in accordance with at least one embodiment. In at least one embodiment, a software program 702 is a software module. In at least one embodiment, a software program 702 comprises one or more software modules. In at least one embodiment, one or more APIs 710 are sets of software instructions that, if executed, cause one or more processors to perform one or more computational operations. In at least one embodiment, one or more APIs 710 are distributed or otherwise provided as a part of one or more libraries 706, runtimes 704, drivers 704, and/or any other grouping of software and/or executable code further described herein. In at least one embodiment, one or more APIs 710 perform one or more computational operations in response to invocation by software programs 702. In at least one embodiment, a software program 702 is a collection of software code, commands, instructions, or other sequences of text to instruct a computing device to perform one or more computational operations and/or invoke one or more other sets of instructions, such as APIs 710 or API functions 712, to be executed. In at least one embodiment, functionality provided by one or more APIs 710 includes software functions 712, such as those usable to accelerate one or more portions of software programs 702 using one or more parallel processing units (PPUs), such as graphics processing units (GPUs). In at least one embodiment, a software program is a compiler.

In at least one embodiment, APIs 710 are hardware interfaces to one or more circuits to perform one or more computational operations. In at least one embodiment, one or more software APIs 710 described herein are implemented as one or more circuits to perform one or more techniques described below in conjunction with FIGS. 2-6. In at least one embodiment, one or more software programs 702 comprise instructions that, if executed, cause one or more hardware devices and/or circuits to perform one or more techniques further described below in conjunction with FIGS. 2-6.

In at least one embodiment, software programs 702, such as user-implemented software programs, utilize one or more application programming interfaces (APIs) 710 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 710 provide a set of callable functions 712, referred to herein as APIs, API functions, and/or functions, that individually perform one or more computing operations, such as computing operations related to parallel computing. For example, in an embodiment, one or more APIs 710 provide functions 712 to cause neural network 716 to dynamically correlate metadata to an original document and generate training labels for natural language processing tasks.

In at least one embodiment, one or more software programs 702 interact or otherwise communicate with one or more APIs 710 to perform one or more computing operations using one or more PPUs, such as GPUs. In at least one embodiment, one or more computing operations using one or more PPUs comprise at least one or more groups of computing operations to be accelerated by execution at least in part by the one or more PPUs. In at least one embodiment, one or more software programs 702 interact with one or more APIs 710 to facilitate parallel computing using a remote or local interface.

In at least one embodiment, an interface is software instructions that, if executed, provide access to one or more functions 712 provided by one or more APIs 710. In at least one embodiment, a software program 702 uses a local interface when a software developer compiles one or more software programs 702 in conjunction with one or more libraries 706 comprising or otherwise providing access to one or more APIs 710. In at least one embodiment, one or more software programs 702 are compiled statically in conjunction with pre-compiled libraries 706 or uncompiled source code comprising instructions to perform one or more APIs 710. In at least one embodiment, one or more software programs 702 are compiled dynamically and the one or more software programs utilize a linker to link to one or more pre-compiled libraries 706 comprising one or more APIs 710.

In at least one embodiment, a software program 702 uses a remote interface when a software developer executes a software program that utilizes or otherwise communicates with a library 706 comprising one or more APIs 710 over a network or other remote communication medium. In at least one embodiment, one or more libraries 706 comprising one or more APIs 710 are to be performed by a remote computing service, such as a computing resource services provider. In another embodiment, one or more libraries 706 comprising one or more APIs 710 are to be performed by any other computing host providing the one or more APIs 710 to one or more software programs 702.

In at least one embodiment, a processor performing or using one or more software programs 702 calls, uses, performs, or otherwise implements one or more APIs 710 to allocate and otherwise manage memory to be used by the software programs 702. In at least one embodiment, one or more software programs 702 utilize one or more APIs 710 to allocate and otherwise manage memory to be used by one or more portions of the software programs 702 to be accelerated using one or more PPUs, such as GPUs or any other accelerator or processor further described herein. Those software programs 702 request a neural network to perform document annotation, label generation, and/or training or inference operations using functions 712 provided, in an embodiment, by one or more APIs 710.

In at least one embodiment, an API 710 is an API to facilitate parallel computing. In at least one embodiment, an API 710 is any other API further described herein. In at least one embodiment, an API 710 is provided by driver and/or runtime software 704. In at least one embodiment, an API 710 is provided by a CUDA user-mode driver. In at least one embodiment, an API 710 is provided by a CUDA runtime. In at least one embodiment, driver and/or runtime software 704 is data values and software instructions that, if executed, perform or otherwise facilitate operation of one or more functions 712 of an API 710 during load and execution of one or more portions of a software program 702. In at least one embodiment, a runtime 704 is data values and software instructions that, if executed, perform, or otherwise facilitate operation of one or more functions 712 of an API 710 during execution of a software program 702. In at least one embodiment, one or more software programs 702 utilize one or more APIs 710 implemented or otherwise provided by driver and/or runtime software 704 to perform combined arithmetic operations by the one or more software programs 702 during execution by one or more PPUs, such as GPUs.

In at least one embodiment, one or more software programs 702 utilize one or more APIs 710 provided by driver and/or runtime software 704 to perform combined arithmetic operations of one or more PPUs, such as GPUs. In at least one embodiment, one or more APIs 710 provide combined arithmetic operations through driver and/or runtime software 704, as described above. In at least one embodiment, one or more software programs 702 utilize one or more APIs 710 provided by driver and/or runtime software 704 to allocate or otherwise reserve one or more blocks of memory 714 of one or more PPUs, such as GPUs. In at least one embodiment, one or more software programs 702 utilize one or more APIs 710 provided by driver and/or runtime software 704 to allocate or otherwise reserve blocks of memory. In at least one embodiment, one or more APIs 710 are to perform combined arithmetic operations, as described below in conjunction with any of FIGS. 1-6.

To improve software programs 702 usability and/or optimization of one or more portions of the software programs 702 to be accelerated by one or more PPUs, such as GPUs, in an embodiment, one or more APIs 710 provide one or more API functions 712 to perform a neural network usable or used by one or more computing devices as described above and further described below in conjunction with FIGS. 1-6. In at least one embodiment, an exemplary block diagram 700 depicts a processor, comprising one or more circuits to perform one or more software programs to combine two or more application programming interfaces (APIs) into a single API. In at least one embodiment, an exemplary block diagram 700 depicts a system, comprising one or more processors to perform one or more software programs to combine two or more application programming interfaces (APIs) into a single API. In at least one embodiment, a processor uses an API to cause a neural network to dynamically correlate metadata with an original document and, as a result, generate training label for natural language processing. In at least one embodiment, an exemplary block diagram 700 illustrates an API to invoke a neural network to cause dynamic document annotation.

In at least one embodiment, a processor uses an exemplary API to invoke one or more neural networks, where the processor comprises circuitry to use one or more first neural networks to generate one or more first images from a viewpoint outside of an object based, at least in part, on depth information generated using one or more second neural networks and feature information generated by one or more third neural networks and/or otherwise perform operations described herein. In at least one embodiment, parts, methods and/or a system described in connection with FIG. 7 are as further illustrated non-exclusively in any FIG. 1-7.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 8 is an illustrative, simplified block diagram of a computing device 800 that can be used to practice at least one embodiment of the present disclosure. In various embodiments, the computing device 800 includes any appropriate device operable to send and/or receive requests, messages, or information over an appropriate network and convey information back to a user of the device. The computing device 800 may be used to implement any of the systems illustrated and described above. For example, the computing device 800 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 800 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 8, the computing device 800 may include one or more processors 802 that, in embodiments, communicate with and are operatively coupled to a number of peripheral subsystems via a bus subsystem. In some embodiments, these peripheral subsystems include a storage subsystem 806, comprising a memory subsystem 808 and a file/disk storage subsystem 810, one or more user interface input devices 812, one or more user interface output devices 814, and a network interface subsystem 816. Such storage subsystem 806 may be used for temporary or long-term storage of information.

In some embodiments, the bus subsystem 804 may provide a mechanism for enabling the various components and subsystems of computing device 800 to communicate with each other as intended. Although the bus subsystem 804 is shown schematically as a single bus, alternative embodiments of the bus subsystem utilize multiple buses. The network interface subsystem 816 may provide an interface to other computing devices and networks. The network interface subsystem 816 may serve as an interface for receiving data from and transmitting data to other systems from the computing device 800. In some embodiments, the bus subsystem 804 is utilized for communicating data such as details, search terms, and so on. In an embodiment, the network interface subsystem 816 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 816 is enabled by wired and/or wireless connections and combinations thereof.

In some embodiments, the user interface input devices 812 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 800. In some embodiments, the one or more user interface output devices 814 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 800. The one or more user interface output devices 814 can be used, for example, to present user interfaces to facilitate user interaction with applications performing processes described and variations therein, when such interaction may be appropriate.

In some embodiments, the storage subsystem 806 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 806. These application modules or instructions can be executed by the one or more processors 802. In various embodiments, the storage subsystem 806 additionally provides a repository for storing data used in accordance with the present disclosure. In some embodiments, the storage subsystem 806 comprises a memory subsystem 808 and a file/disk storage subsystem 810.

In embodiments, the memory subsystem 808 includes a number of memories, such as a main random access memory (RAM) 818 for storage of instructions and data during program execution and/or a read only memory (ROM) 820, in which fixed instructions can be stored. In some embodiments, the file/disk storage subsystem 810 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 800 includes at least one local clock 824. The at least one local clock 824, in some embodiments, is a counter that represents the number of ticks that have transpired from a particular starting date and, in some embodiments, is located integrally within the computing device 800. In various embodiments, the at least one local clock 824 is used to synchronize data transfers in the processors for the computing device 800 and the subsystems included therein at specific clock pulses and can be used to coordinate synchronous operations between the computing device 800 and other systems in a data center. In another embodiment, the local clock is a programmable interval timer.

The computing device 800 could be of any of a variety of types, including a portable computer device, tablet computer, a workstation, or any other device described below. Additionally, the computing device 800 can include another device that, in some embodiments, can be connected to the computing device 800 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 800 for processing. Due to the ever-changing nature of computers and networks, the description of the computing device 800 depicted in FIG. 8 is intended only as a specific example for purposes of illustrating the preferred embodiment of the device. Many other configurations having more or fewer components than the system depicted in FIG. 8 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 800 may include any appropriate hardware, software, and firmware for integrating with a data store as needed to execute aspects of one or more applications for the computing device 800 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 800 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 800 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 800 may provide the content in one or more forms including, but not limited to, forms that are perceptible to the user audibly, visually, and/or through other senses. The handling of requests and responses, as well as the delivery of content, in an embodiment, is handled by the computing device 800 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 800 typically will include an operating system that provides executable program instructions for the general administration and operation of the computing device 800 and includes a computer-readable storage medium (e.g., a hard disk, random access memory (RAM), read only memory (ROM), etc.) storing instructions that if executed (e.g., as a result of being executed) by a processor of the computing device 800 cause or otherwise allow the computing device 800 to perform its intended functions (e.g., the functions are performed as a result of one or more processors of the computing device 800 executing instructions stored on a computer-readable storage medium).

In an embodiment, the computing device 800 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 800 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof. In an embodiment, the computing device 800 is capable of storing, retrieving, and accessing structured or unstructured data. In an embodiment, computing device 800 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention, and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A system, comprising:
one or more processors; and
memory that stores computer-executable instructions that, as a result of execution by the one or more processors, cause the system to at least:
at a first time, obtain a document pair, comprising:
a document; and
metadata comprising a set of field-value pairs corresponding to contents of the document;
at a second time after the first time, extract a field type and a field value from the set of field-value pairs of the metadata;
generate a query derived from both the field type and the field value;
identify a plurality of candidate locations in the document, wherein the plurality of candidate locations is predicted by the system as potential locations within the document where the field type and the field value might be located;
generate a set of scores by causing the system to:
identify data proximate to each candidate location of the plurality of candidate locations; and
input the query and the data into a neural network to produce a score indicating a likelihood of the candidate location satisfying the query;
determine, based on the set of scores, a determined location from the plurality of candidate locations that likely corresponds to the field type and the field value; and
produce an annotation that corresponds to a bounding box enclosing the field type or field value and identifies the determined location as corresponding to the field type.

2. The system of claim 1, wherein the query is a natural language query.

3. The system of claim 1, wherein the computer-executable instructions that identify the plurality of candidate locations include instructions that cause the system to use string matching to identify the plurality of candidate locations.

4. The system of claim 1, wherein the plurality of candidate locations are identified based, at least in part, on a knowledge base that maps information to the metadata, the knowledge base comprising one or more synonyms, acronyms, or names of new entities generated by combining at least two entities related to the metadata.

5. (canceled)

6. A method, comprising:
at a first time, obtaining a document and metadata about the document corresponding to the document, wherein the metadata comprises information that describes characteristics of the document;
at a second time after the first time, extracting a field type from the metadata about the document;
generating a query using the field type;
identifying a plurality of candidate locations in the document to be annotated, wherein the plurality of candidate locations are predicted to be potential locations within the document where the field type are projected to be located;
generating, using a neural network, a set of scores for the set of candidate locations, the set of scores indicating a likelihood of individual candidate locations satisfying the query;
determining, based on the set of scores, a determined location from the plurality of candidate locations that corresponds to the field type; and
generating an annotation that corresponds to a bounding box that encloses a predicted location of the field type and identifies the determined location as corresponding to the field type.

7. The method of claim 6, wherein identifying the set of candidate locations comprises identifying an overlap between information associated with the metadata and information associated with data locations in the document, the overlap comprising an overlap value that reaches a value relative to a first threshold.

8. The method of claim 6, wherein the determined location comprises coordinates of a coordinate system corresponding to the bounding box of the determined location.

9. The method of claim 6, wherein a score of the set of scores satisfies the query based, at least in part, on using the score reaching a value relative to a second threshold as input to the neural network.

10. The method of claim 6, wherein identifying the set of candidate locations includes using the query and the document, as input to one or more neural networks to identify the set of candidate locations.

11. (canceled)

12. The method of claim 6, further comprising:
storing a data object comprising the annotation that identifies the determined location;
providing the data object as training data to a second neural network; and
training the second neural network to perform at least one of training or an inference by adjusting one or more parameters of the second neural network based at least in part on the data object.

13. The method of claim 6, wherein the neural network is an encoder-based model.

14. A non-transitory computer-readable storage medium storing thereon executable instructions that, as a result of being executed by one or more processors of a computer system, cause the computer system to at least:
at a first time, obtain a document and metadata comprising a set of field-value pairs about the document;
at a second time after the first time, extract a metadata pair from the set of field-value pairs of the metadata;
generate, using the metadata pair, a query;
identify a plurality of candidate locations in the document, wherein the plurality of candidate locations corresponds to probable locations within the document for the metadata pair;
for each candidate location of the plurality of candidate locations, generate a set of scores by causing the computer system to:
identify data adjacent to each candidate location of the plurality of candidate locations; and
input the query and the data into a neural network to produce a score indicating whether a candidate location of the plurality of candidate locations satisfies the query;
determine, based on the set of scores, a determined location from the plurality of candidate locations that corresponds to a bounding box enclosing a likely location of the metadata pair in the document; and
produce an annotation that identifies the determined location as corresponding to the metadata.

15. The non-transitory computer-readable storage medium of claim 14, wherein the query is a natural language query.

16. The non-transitory computer-readable storage medium of claim 14, wherein the set of scores are generated based, at least in part, on a parameter comprising a size of text around the plurality of candidate locations.

17. (canceled)

18. The non-transitory computer-readable storage medium of claim 14, wherein generating the query comprises:
transforming the metadata of the document to produce transformed metadata; and
deriving the query from the transformed metadata.

19. The non-transitory computer-readable storage medium of claim 14, wherein the executable instructions further comprise instructions that further cause the computer system to cause a second neural network to modify subsequent metadata based, at least in part, on the set of scores.

20. The non-transitory computer-readable storage medium of claim 14, wherein the executable instructions further comprise instructions that further cause the computer system to at least:
store a data object comprising the annotation; and
cause a second neural network to generate at least one of an inference or a prediction using the data object.

21. The system of claim 1, the computer-executable instructions include instructions that further cause the system to generate a dataset comprising the annotation, wherein the dataset is to be provided as input for training an additional neural network.

22. The system of claim 1, wherein the plurality of candidate locations are locations within an image of the document.

23. The method of claim 6, wherein the metadata is obtained from a markup language file.
